(19) United States
(12) Patent Application Publication
(10) Pub. No.: US 2025/0269915 A1
(43) Pub. Date: Aug. 28, 2025

(54) AIRFLOW INDUCER FOR HEAT EXCHANGE COOLING, DIRECTIONAL TRUST AND DRAG REDUCTION

(71) Applicant: FCA US LLC, Auburn Hills, MI (US)

(72) Inventors: Travis D Bechtel, Goodrich, MI (US); Zachary A Luetzen, West Bloomfield, MI (US); Mark E Stout, Auburn Hills, MI (US); Brandon F Brady, Lapeer, MI (US)

(21) Appl. No.: 18/587,348

(22) Filed: Feb. 26, 2024

(51) Int. Cl. B62D 37/02; B62D 35/00

(52) U.S. Cl. CPC B62D 37/02; B62D 35/007

(57) ABSTRACT

An air flow inducer system in a vehicle provides cooling, thrust and drag reduction in the vehicle. It has a source to generate a pressurized air flow. An air inducer receives the pressurized air flow. A chamber is coupled with the air inducer such that the air inducer creates a low pressure in the chamber during flow of the pressurized air. The low pressure chamber is coupled with an underside of a vehicle such that the low pressure creates a downward force on the vehicle. An entrainment nozzle is coupled with the air inducer to direct air flow toward heated elements that require cooling. An exhaust directs air flow exiting the system to provide directional thrust or drag reduction.

### FIELD

The present disclosure relates to an automotive vehicle and, more particularly, to an air inducer system that provides cooling and thrust and drag reduction.

### BACKGROUND

This section provides background information related to the present disclosure which is not necessarily prior art.

Certain practical devices require the generation of a low pressure or vacuum to create a desired force effect or transfer/convey material without routing undesirable contaminants or material through a type of impeller/pump used to create the vacuum pressure differential. In these same applications, it can be advantageous to use the motive flow of the device to absorb/remove heat that may have been generated in the creation of the motive pressure differential and/or airflow or to other systems that may be supportive to the device or system that the device supports.

Fuel cell vehicles require a high-volume compressed air source in order to feed the atmospheric oxygen to react with the hydrogen in the fuel cell stack. This type of compressor is adequate to drive an air flow inducer as a means to provide heat exchanger air flow. In this application, a portion of the flow to feed the fuel cell would be diverted to a flow inducer. Fuel cell vehicles have multiple heat exchanger cooling needs without the need for a down force system, but they are equipped with a high volume compressor to provide oxygen to the fuel cell stack. This combination of hardware presents an opportunity to have the compressor cooling air flow through an inducer or inducer entrainment nozzle as a mechanism to avoid additional or separate cooling fans.

Known solutions for power downward force generating vehicles are not able to robustly use the air flow that is needed to create down force to cool the other systems on the vehicle. These vehicles either use separate power sources for cooling flow or they employ filtration/separators systems for dual purpose air flow usage. Additionally, these designs limit the ability to achieve downward force and regulate the air flow needed for cooling and/or down force thrust drag reduction simultaneously.

The filtration or separator systems needed to protect the longevity and performance of the impeller have several drawbacks. First is the added weight and packaging space required for these features to be in the flow path and serviceable when they become filled or clogged. Secondly, they reduce pressure flow either when new or cleaned and continue to degrade pressure flow as they collect material that risks damage to the impeller generating the air flow. Lastly, the system could become completely disabled in any off track excursion into a speed arresting sand trap, grass area or an area of the track when worn tire rubber or other debris may have been collected. Conventional axial flow cooling fans are not able to generate significant pressure drop on the inflow side or pressure increase on the outflow side. This is a limiting factor for how much resistance to airflow the heat exchanger design can employ in terms of fin density and length/diameter ratio. The high flow axial fan systems used for cooling presents challenges for controlling audible noise and sound quality.

Pushing the dynamic limits of high performance battery electric vehicle creates unique challenges for vehicle designers. Currently, carrying adequate onboard battery power at enough energy potential to meet range and output targets leads to increased vehicle mass over internal combustion engine powered vehicles and increased complexity to keep battery and drive motor systems cool at extreme discharge and recharge rates. Increasingly, car builders are looking to active and powered aerodynamic aids to compensate for the onboard battery mass and improve/differentiate their on-track performance.

### SUMMARY

According to the present disclosure, the disclosure eliminates the need for additional fan systems to improve cooling air flow on a vehicle with a powered downward force system. The present disclosure has the ability to backflow, clear and purge, a primary flow path into the air inducer inlet by blocking the inducer outlet downstream of the compressed air inlet. This significantly reduces possibility of creating a compressor surge condition due to an inlet restriction or outlet restriction at high compressor speed. The present disclosure has the ability to tolerate dust and debris passing through the inducer inlet without risking damage to the compressor impeller. The present disclosure has the ability to modulate cooling air flow and power demands by throttling the compressor speed and varying the inlet flow from the inducer. The present disclosure has an ability to generate large differential pressure and air flow volume for cooling without placing a bladed impeller device at an exposed location requiring specific acoustic treatments or comprised performance strategies. The present disclosure has the ability to exhaust the down force or cooling air flow at a flow rate that can provide meaningful amounts of thrust or drag reduction to improve dynamic performance. The present disclosure has the ability to be employed within the compressed air supply side of a fuel cell stack to drive air inducer/entrainment nozzle for the purpose of cooling the system of the fuel cell vehicle. The present disclosure utilizes compressed air source with an optimized inducer that allows air to be moved without putting an impeller blade in an exposed location that requires acoustic treatments that can add mass and complexity.

According to a first aspect of the disclosure, a vehicle air flow inducer system that provides cooling and thrust and drag reduction in the vehicle comprises a source for generating a pressurized air flow with an air inducer to receive the pressurized air flow. A chamber is coupled with the air inducer such that the air inducer creates a low pressure in the chamber during flow of the pressurized air. The low pressure chamber is coupled with an underside of a vehicle such that presence of the low pressure creates a downward force on the vehicle. An entrainment nozzle is coupled with the air inducer to direct air flow toward heated elements that require cooling. An exhaust directs air flow exiting the system to provide directional thrust or drag reduction. The source for generating pressurized air flow is a compressor, storage tank, accumulator or the like. The chamber is defined by a closed skirt extending toward the ground from the underside of the vehicle. The entrainment nozzle includes an outlet and a first inlet to draw ambient air into the entrainment nozzle and a second inlet to receive air flow from the air inducer. The first inlet may direct the air flow to heated elements or the outlet may direct the air flow to heated elements or both and may direct the air flow to the heated elements. The exhaust directs the air flow to a spoiler, body panel, scoop or the like. A purge valve is coupled with the air inducer to restrict flow through the air inducer. A filter screen is positioned between the air inducer and chamber to filtering air flow into the air inducer. The heating elements may be brakes, motors, batteries, suspension components or the like.

According to a second aspect of the disclosure, a vehicle has a body with an underside comprising a source for generating a pressurized air flow with an air inducer to receive the pressurized air flow. A chamber is coupled with the air inducer such that the air inducer creates a low pressure in the chamber during flow of the pressurized air. The low pressure chamber is coupled with an underside of a vehicle such that presence of the low pressure creates a downward force on the vehicle. An entrainment nozzle is coupled with the air inducer to direct air flow toward heated elements that require cooling. An exhaust directs air flow exiting the system to provide directional thrust or drag reduction. The source for generating pressurized air flow is a compressor, storage tank, accumulator or the like. The chamber is defined by a closed skirt extending toward the ground from the underside of the vehicle. The entrainment nozzle includes an outlet and a first inlet to draw ambient air into the entrainment nozzle and a second inlet to receive air flow from the air inducer. The first inlet may direct the air flow to heated elements or the outlet may direct the air flow to heated elements or both and may direct the air flow to the heated elements. The exhaust directs the air flow to a spoiler, body panel, scoop or the like. A purge valve is coupled with the air inducer to restrict flow through the air inducer. A filter screen is positioned between the air inducer and chamber to filtering air flow into the air inducer. The heating elements may be brakes, motors, batteries, suspension components or the like.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a vehicle in accordance with the disclosure.

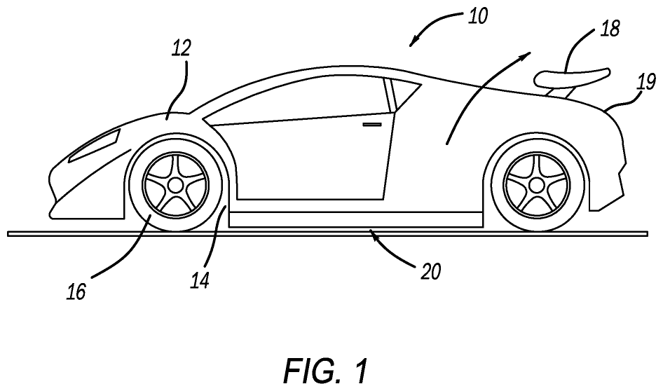

FIG. 2 illustrates a schematic view of an air flow inducer system.

FIG. 3 is a schematic view of an air inducer in accordance with the disclosure.

FIG. 4 is a schematic view like FIG. 3 in a second position.

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle 10 includes a body 12 with an underside 14 and wheels 16. The body includes a spoiler 18 positioned at the rear of the vehicle body. A skirt 20 extends from the underside of the vehicle 14.

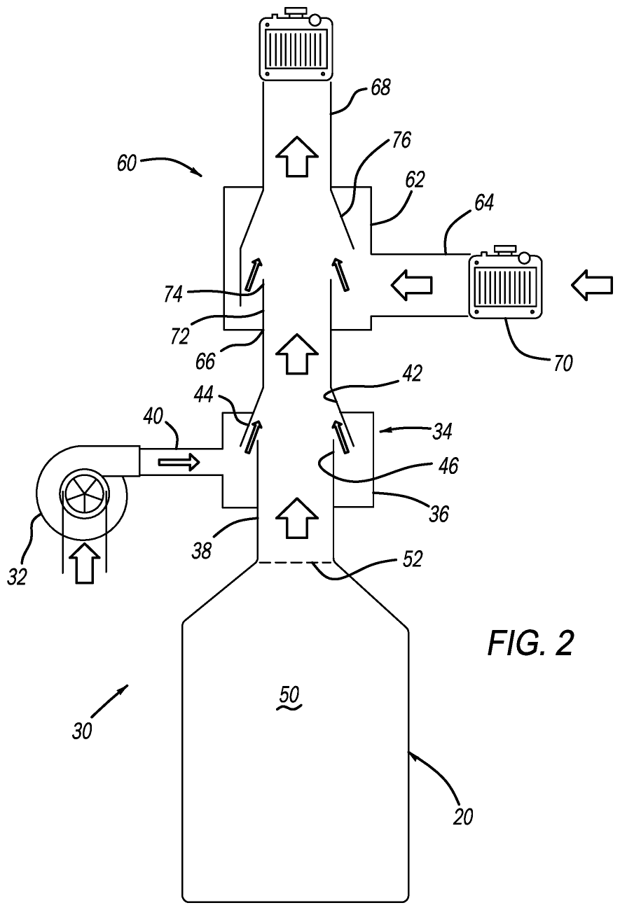

The skirt 20 extends downward from the underside 14 of the vehicle 10 towards the ground. The skirt 20 maintains a gap between the low pressure region under the vehicle 10 and the road surface. By vacuuming air from the region and restricting the flow of back air, the control of the air gap creates a zone of low pressure that pushes the car towards the ground to improve tire adhesion. The skirt 20 has a closed configuration shape, such as a rectangle, as illustrated in schematic form in FIG. 2.

The air inducer system 30 is illustrated in FIG. 2. The system 30 includes a compressor 32 mounted in the vehicle 10. The compressor 10 includes an inlet and an outlet directing a high pressure air flow towards an air inducer 34. The compressor 32 could be replaced by an air storage container, accumulator or the like that generates the high pressure.

The air inducer 30 includes a box 36, inlets 38, 40, as well as an outlet 42. The box 36 receives the high pressure air flow via the inlet 40. The inlet 38 includes a tube portion extending into the box 36. The outlet 42 includes a conical portion 44 positioned adjacent the end of the tube portion 46. Thus, as the high pressure air flow is directed into the box 36, it is moved towards the outlet 42. The outlet 42, with its conical portion 44 surrounding the end 46 of the inlet tube, creates a vacuum or negative pressure in the chamber 50 created by the skirt 20. Thus, this creates the low pressure air underneath the vehicle. A screen or filter 52 is positioned at the junction of the inlet and the skirt 20 defining the chamber 50. This filter 52 prohibits debris and the like from entering into the air inducer 34.

The outlet 42 extends into the entrainment nozzle 60. The entrainment nozzle 60 includes a box 62, a first inlet 64, a second inlet 66 and an exhaust 68. The inlet 64 enables ambient air to be drawn into the entrainment nozzle 60. The ambient air may pass a heat exchanger element 70, such as a vehicle brake, an electric motor, a suspension element or the like. Thus, as the air is drawn into the entrainment nozzle 60 from ambient, the air is used to cool these various heated components.

The second inlet 66 receives the tube portion 72 of the outlet 42. The tube portion 72 has an end 74 that terminates in an enlarged portion 76 of the exhaust 68. Thus, as the air flow enters into the entrainment nozzle 60 from the air inducer 34, a vacuum is created to pull the ambient air into the exhaust 68 via the high pressure air flow exiting the air inducer 60 into the entrainment nozzle 60. Thus, the high pressure airflow continues through the exhaust 68. The exhaust 68 may direct the air flow toward an additional heat exchanger or heated element such as a battery fuel cell or the like to cool the heated element.

Additionally, the exhaust exits the air flow through the vehicle. The exhaust could be directed towards a spoiler 18, a body panel 19, scoop 21 or the like at the rear of the vehicle 10. As the air flow exits the vehicle 10, the force of the drag is reduced due to the air directed out of the body.

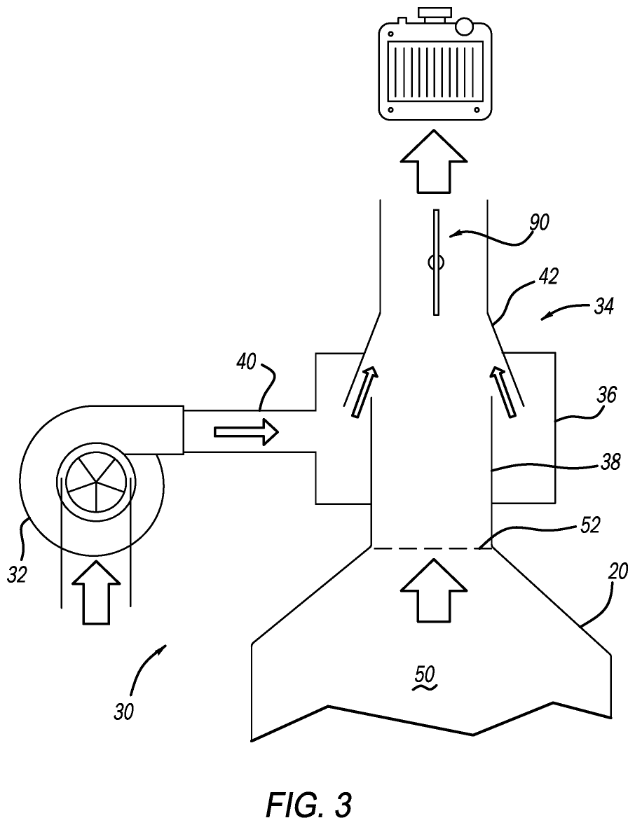

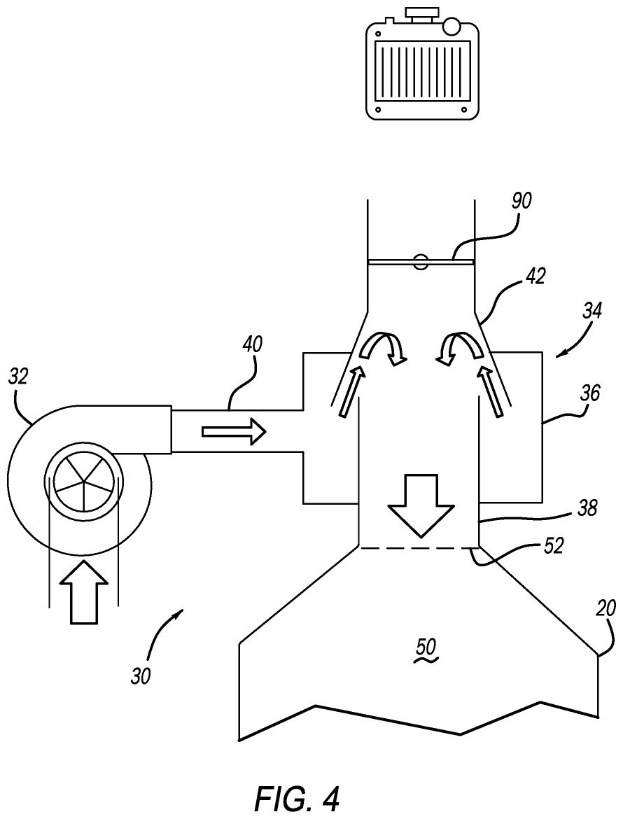

FIGS. 3 and 4 illustrate a purge valve 90 positioned in the outlet tube 42 of the air inducer 34. The purge valve 90 in FIG. 3, is illustrated in an opened position and in a closed position in FIG. 4. Here, the valve 90 is closed so that a back flow is created, as illustrated in FIG. 4, from the high pressure air that enters into the inducer from the compressor. Thus, the high pressure air is forced into the low pressure chamber 50 through the screen or filter 52. As it is forced through the screen or filter 52, the debris or the like is blown off or discharged from the screen or filter and falls under the vehicle. Thus, the debris or the like is eliminated from the filter or the screen in an efficient manner.

The air flow inducer system 30 creates a combination of air sources that have different states of motion, pressure and temperature. This creates opportunities to optimize the performance of the device it is applied on. One such device could be a high performance vehicle application where a low pressure area creates a downward force to enhance tractive force to the ground. Such a vehicle would likely have to create this flow from an onboard motor/pump that would require cooling at high load conditions. The vehicle may have an internal combustion engine on an electric motor to move the vehicle at the ground plane that would require powerful heat rejection air flow due to enhanced traction provided by the added down force generated. If the vehicle is battery powered, the high charge and discharge rates needed to power the compressor and ground drive motors would require a large amount of air flow for heat rejection to maintain the performance and durability of the battery and power management system and could include cooling of the conductor connecting these devices.

In a high performance vehicle application, the air flow created by the inducer system can also be exhausted from the vehicle in a manner that creates desirable thrust and/or drag reduction after being routed through heat exchangers or bypass the heat exchangers when cooling is not needed. The thrust can be directed in a manner that presses the chassis to the ground to increase tractive force or in a manner that pushes the vehicle forward or laterally to improve acceleration, speed or handling response. Additionally, the exit of the air flow can be routed in a manner that reduces the aerodynamic drag of the vehicle for the purpose of increasing top speed, improving efficiency at lower speeds or achieving a specific styling body length/shape without an aerodynamic speed or efficiency degradation. The air flow inducer system is uniquely capable of creating large pressure drops or positive head pressure of an air flow for multiple purposes onboard a high performance electric vehicle.

The concept can take in large amounts of air from areas of the vehicle that may contain amounts of dirt/dust that would degrade the performance of other systems that must pass the material through an impeller directly or separate the material via a separator filter. These filters and separators add mass requiring packaging space and generally degrade the system performance overall and over time between a required cleaning maintenance. Designers can use the pressure drop to create a suction force to improve handling to overcome the added EV mass and/or pull air through heat exchangers. The high pressure out flow can be used to push air through heat exchangers and/or direct the air flow in a manner that aids handling thrust or reduces drag around behind the vehicle to increase top speed and increase driving range.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air flow inducer system in a vehicle for providing cooling, thrust and drag reduction in the vehicle comprising:
a source for generating a pressurized air flow;
an air inducer for receiving the pressurized air flow;
a chamber coupled with the air inducer such that the air inducer creates a low pressure in the chamber during flow of the pressurized air, and the low pressure chamber is coupled with an underside of a vehicle such that the low pressure creates a downward force on the vehicle;
an entrainment nozzle coupled with the air inducer for directing air flow toward heated elements that require cooling; and
an exhaust for directing air flow exiting the system for providing directional thrust or drag reduction.

2. The air flow inducer system of claim 1, wherein the source for generating pressurized air flow is a compressor, storage tank, accumulator or the like.

3. The air flow inducer system of claim 1, wherein the chamber is defined by a closed skirt extending toward the ground from the underside of the vehicle.

4. The air flow inducer system of claim 1, wherein the entrainment nozzle includes a first inlet for drawing ambient air into the entrainment nozzle, a second inlet for receiving air flow from the air inducer and an outlet.

5. The air flow inducer system of claim 4, wherein the first inlet may direct the air flow to the heated element, the outlet may direct the air flow to the heated element or both and may direct the air flow to the heated elements.

6. The air flow inducer system of claim 1, wherein the exhaust directs the air flow to a spoiler, body panel, scoop or the like.

7. The air flow inducer system of claim 1, further including a purge valve coupled with the air inducer for restricting flow through the air inducer.

8. The air flow inducer system of claim 1, further including a filter screen between the air inducer and chamber for filtering air flow into the air inducer.

9. The air flow inducer system of claim 1, wherein the heated element may be brakes, motors, batteries, suspension components or the like.

10. A vehicle having a body with an underside comprising:
a source for generating a pressurized air flow;
an air inducer for receiving the pressurized air flow;
a chamber coupled with the air inducer such that the air inducer creates a low pressure in the chamber during flow of the pressurized air, and the low pressure chamber is coupled with the underside of the vehicle such that the low pressure creates a downward force on the vehicle;
an entrainment nozzle coupled with the air inducer for directing air flow toward heated elements that require cooling; and
an exhaust for directing air flow exiting the system for providing directional thrust or drag reduction.

11. The vehicle of claim 10, wherein the source for generating pressurized air flow is a compressor, storage tank, accumulator or the like.

12. The vehicle of claim 10, wherein the chamber is defined by a closed skirt extending toward the ground from the underside of the vehicle.

13. The vehicle of claim 10, wherein the entrainment nozzle includes a first inlet for drawing ambient air into the entrainment nozzle, a second inlet for receiving air flow from the air inducer and an outlet.

14. The vehicle of claim 13, wherein the first inlet may direct the air flow to the heated element, the outlet may direct the air flow to the heated element or both may direct the air flow to the heated elements.

15. The vehicle of claim 10, wherein the exhaust directs the air flow to a spoiler, body panel, scoop or the like.

16. The vehicle of claim 10, further including a purge valve coupled with the air inducer for restricting flow through the air inducer.

17. The vehicle of claim 10, further including a filter screen between the air inducer and chamber for filtering air flow into the air inducer.

18. The vehicle of claim 10, wherein the heated element may be brakes, motors, batteries, suspension components.
